(19) United States
(12) Patent Application Publication
(10) Pub. No.: US 2013/0041753 A1
(43) Pub. Date: Feb. 14, 2013

(54) System and Method for Identifying a Path of a Billboard Audience Group and Providing Advertising Content Based on the Path

(71) Applicants: Ajay Sathyanath, Edison, NJ (US); Thyagarajan Nandagopal, Edison, NJ (US)

(72) Inventors: Ajay Sathyanath, Edison, NJ (US); Thyagarajan Nandagopal, Edison, NJ (US)

(73) Assignee: ALCATEL-LUCENT USA INC., Murray Hill, NJ (US)

(21) Appl. No.: 13/538,155

(22) Filed: Jun. 29, 2012

Related U.S. Application Data
(60) Provisional application No. 61/521,407, filed on Aug. 9, 2011.

(51) Int. Cl. G06Q 30/02

(52) U.S. Cl. 705/14.58

(57) ABSTRACT

A plurality of mappings corresponding to respective points of interest is generated. Each mapping indicates at least one group detected at the corresponding point of interest and respective times when each respective group among the at least one group was detected at the corresponding point of interest. A standard representation corresponding to a set of one or more groups appearing in a selected one of the plurality of mappings is defined. A path associated with the standard representation is determined, based on the plurality of mappings, the path defining a second plurality of points of interest at which the standard representation was detected and time information indicating when the standard representation was detected at each respective point of interest within the second plurality of points of interest. A point of interest may comprise a location associated with a billboard.

This application claims the benefit of U.S. Provisional Patent Application No. 61/521,407, filed on Aug. 9, 2011, which is hereby incorporated by reference.

### TECHNICAL FIELD

This specification relates generally to systems and methods for identifying and tracking a target group for marketing purposes, and more particularly to systems and methods for identifying a path of a billboard audience group and providing advertising content based on the path.

### BACKGROUND

Billboards are a commonly used form of advertising. Billboards are used along roads, in shopping malls, on the sides of buildings, and in many other environments. As advertising techniques become more sophisticated, and the knowledge of target audiences expands and becomes increasingly refined, advertisers are increasingly able to selectively place billboards to reach target audiences. In addition, recent technologies allow the placement of billboards that can show a first advertisement at a first time of the day and a second advertisement at a second time of the day.

As billboards become increasingly targeted to select audiences, and additionally include technology enabling them to interact among themselves, it has become increasingly evident that the concept of a target audience is a free flowing dynamic entity that moves and is present in front of multiple billboards at multiple points in time. In order to achieve efficiency and maximize returns, there is a need for systems and methods that allow a billboard, or a network of billboards, to identify and respond to the movement of the target audience. Furthermore, there is a need for systems and methods capable of tracking and monitoring a target group without infringing on individual privacy.

### SUMMARY

In various embodiments, systems and methods for detecting the presence of a target audience or group in front of, or in the vicinity of, one or more points of interest are provided. A movement, or path, of the target audience among points of interest is determined. For example, a target audience may be detected at respective time intervals in front of various billboards within a network of billboards, and a path of the target audience among the billboards may be determined. In order to identify a group at a specific point of interest during one or more time intervals, a notion of a standard representation of the group is defined. In order to identify a standard representation of a group at multiple points of interest, a notion of a standard occurrence is defined. A path is identified by arranging the standard occurrences chronologically across multiple points of interest. A path indicates that a selected group is travelling across time and past multiple points of interest.

In accordance with an embodiment, a plurality of mappings corresponding to respective points of interest is generated. Each mapping indicates at least one group of interest detected at the corresponding point of interest and respective times when each respective group was detected at the corresponding point of interest. A standard representation corresponding to a set of one or more groups appearing in a selected one of the plurality of mappings is defined. A path associated with the standard representation is determined, based on the plurality of mappings, the path defining a second plurality of points of interest at which the standard representation was detected and time information indicating when the standard representation was detected at each respective point of interest within the second plurality of points of interest. In one embodiment, at least one point of interest comprises a location associated with a billboard.

In one embodiment, the set of one or more groups is detected in an area associated with a particular point of interest corresponding to the selected one of the plurality of mappings.

In another embodiment, an intersection of the set of one or more groups is determined, a probabilistic growth around the intersection is determined, and the standard representation is defined based on the intersection and the probabilistic growth.

In another embodiment, an array associated with the standard representation is generated, based on the plurality of mappings. The array comprises one or more sets of coordinates associating respective points of interest with respective times, the array being generated by identifying, within the plurality of mappings, a plurality of standard occurrences of the standard representation, and for each of the plurality of standard occurrences identified, generating a set of coordinates indicating a time and a point of interest associated with the respective standard occurrence.

In another embodiment, a standard occurrence of the standard representation is identified by identifying a P probabilistic relaxed centered intersection.

In another embodiment, one or more advertisements are displayed at one or more selected points of interest, based on the determined path.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a network of billboards located in a geographical region;

FIG. 2 shows several pluralities of billboards and respective billboard epicenters within each respective plurality in accordance with an embodiment;

FIG. 3 shows a network of billboards within a geographical region and distances between the billboards;

FIG. 4 shows a communication system in accordance with an embodiment;

FIG. 5A shows components of an audience detector in accordance with an embodiment;

FIG. 5B shows components of an audience analysis service in accordance with an embodiment;

FIG. 6 is a flowchart of a method of determining a path associated with a group in accordance with an embodiment;

FIG. 7 shows a mapping in accordance with an embodiment;

FIG. 8 illustrates a path followed by a group in accordance with an embodiment;

FIG. 9 illustrates an analysis of two histograms in accordance with an embodiment;

FIG. 10 illustrates a reduction of an M-modal distribution over a totally ordered group to a N-modal distribution in accordance with an embodiment; and

FIG. 11 shows a computer that may be used to implement certain embodiments of the invention.

### DETAILED DESCRIPTION

As billboards become increasingly targeted to select audiences, and additionally include technology enabling them to interact among themselves, it has become increasingly evident that the concept of a target audience is a free flowing dynamic entity that moves and is present in front of multiple billboards at multiple points in time. In order to achieve efficiency and maximize returns, there is a need for systems and methods that allow a billboard, or a network of billboards, to identify and respond to the movement of the target audience.

In accordance with an embodiment, a movement, or path, of a target audience is identified, and advertisements are selectively placed based on the path.

By assigning various statistical parameters and measuring their nodal densities, it is possible to capture the movement of the target audience in a statistical manner. This statistical measure of nodal density gives rise to a notion of “flow” or “movement” across multiple billboards. A billboard seeking to maximize its returns will have to respond to the movement represented by this statistical measure.

This notion of a statistical quantity and its ability to “flow” or “move” is helpful in selecting and displaying more targeted advertisements. A system which measures such movement can also serve to make suggestions for the billboard owner as to which advertisements will generate the highest sales. The billboard owner can then charge brands based on the time of day the advertisement is shown and also the site at which is shown.

For example an advertisement shown at 4:15 pm at billboard site A, might fetch only $6 CPM (cost per mille), but might fetch $12 CPM if shown at 4:45 pm at the same site or $15 CPM at site B, 200 yards away from site A. The billboard owner can afford to charge the brand owners different rates for the same advertisement, at different sites, and at different times, because as a result of the methods and systems discussed herein, the billboard owner may be able to determine which billboard is likely to produce higher sales for the brand owner.

In the discussion herein, a construct is described that is helpful in determining when a certain characteristic is observed, especially when it is dynamic and especially when the characteristic itself is bound to change.

Current billboard systems cannot identify a target audience that is moving from one site to another site. Current systems fail to gather any information concerning movement in front of a billboard beyond changes relating to changes in time, season etc. Current systems do not gather information concerning changes or movements of a target audience. The term billboard system as used herein signifies a network, or plurality, of billboards that may be employed in a coordinated fashion to display selected advertisements at one or more targeted groups.

Advertisements can be more targeted in nature if billboard systems are able to identify a moving target or group which is in multiple places at multiple points in time. In accordance with an embodiment, a certain audience profile is monitored and tracked across multiple geographic locations, and selected advertisements directed at that target audience may be displayed based on the identified movement. In one example, a billboard system may simply reinforce a certain brand; in another example, a billboard system may follow a certain theme of advertisements; in yet another example, a billboard system may display advertisements that the target audience has not seen along the path the target audience has followed thus far.

Accordingly, advertisements within a billboard system may now follow audiences across geographic locations, across billboards, and even across display mediums, without infringing individuals' privacy. This is possible because only group metrics are followed, and individuals do not matter.

In accordance with an embodiment, a target audience, or group, in front of a particular billboard, is detected and defined. The group is monitored as the group moves along a geography (wide-area), and the paths taken by such a group is determined. There may be multiple groups in front of the same billboard at various times, and each group may move from one billboard to another (within the geography) independently of other groups. The systems and methods described herein are capable of determining the various paths followed by these various groups, and also to determine what these groups are.

It is noted that a group is not a static set of individuals, as the number of people in the group, and the type of people in the group, may vary. Moreover, individuals do not travel in the same group throughout the day. The systems and methods described herein advantageously take a probabilistic view of a group, where a group is defined by the attributes of the various individuals comprising the group, rather than the individuals themselves. A loose set of individuals may be classified as belonging to a predefined group if their common attributes are above a certain probability of intersection.

Once groups are defined in such manner, the probability of finding such a group at a given site (e.g., a billboard site) may be measured. A probability density function of the various groups as a variant of time and space may be defined. If the probability at a given site and a given time is greater than a normalized threshold across all such groups, in more than one site across two or more different times, then it can be determined that such a group has moved from one site to another within that interval of time.

After the paths of these respective groups are determined, advertisements may be displayed on the particular billboards associated with the path to either bolster the previous advertising campaign or display a different advertising campaign. If the group definition includes variables or attributes such as average disposable income, age group, gender, etc, advertisements for a particular billboard may be selected based on selected keywords best suited for display during the times such groups are present. This automatically extends the possibility of interaction among multiple billboards spread over a geography.

Some billboards may include a computer or other type of processor providing a certain level of intelligence. Such intelligent billboards may gather and use information concerning individuals, the movement of groups, and cooperate in a manner that is dictated by each advertisement campaign, rather than in accordance with a predefined static quantity. It is expected that such advertisements will have a higher rate of conversion (higher sales for the brand).

In accordance with an embodiment, improved methods and systems for identifying one or more groups and determining a path of the groups are provided. Mathematical concepts and algorithms that are used to perform these methods are described below.

While systems and methods are described herein in the context of a billboard system, systems and methods described herein may also be implemented in other environments. For example, systems and methods described herein may be used in the study and identification of protein structures, in the study of social or socio-economic group, the study of cancer cells, as well as in other fields such as pattern recognition, image recognition, and computer vision.

### Defining a Group or Target Audience

In accordance with an embodiment, a group is detected among a plurality of people who are present in front of a point of interest, or among a plurality of people who pass near or in front of the point of interest. In one embodiment, the point of interest is a location associated with a billboard. A probabilistic notion of a group is used. As used herein, the term group means a collection of individuals having the same set of characteristics with some spatial or temporal relation. In one embodiment, a group detector attached to a billboard comprises a sensor configured to detect individuals and/or characteristics, and may include hardware or software configured to analyze the data obtained by the sensor to detect and identify a desired group, or set of people. If this type of set is determined to be present across various time intervals (using the standard representation of the group) and across various locations in space (using the corresponding standard occurrence), then the group is considered to be present across these various time intervals and at the various locations.

One example of a characteristic is people of a certain age bracket, perhaps within the same income class, and exhibiting affinity towards gaming systems and electronics. When a characteristic observed at one billboard at a particular time is observed soon thereafter in front of a nearby billboard at another instance of time, and if the individuals associated with the observed characteristic at both billboards intersect with a certain measure of confidence (or probability), then a group with that characteristic is identified.

### Defining a Flow or Path

As the group moves from one point of interest (e.g., a billboard location) to another, the group traces a path. The term path is used interchangeably herein with the term flow. The systems and methods described herein are used to determine the various flows of various groups that are observed within a geographical region.

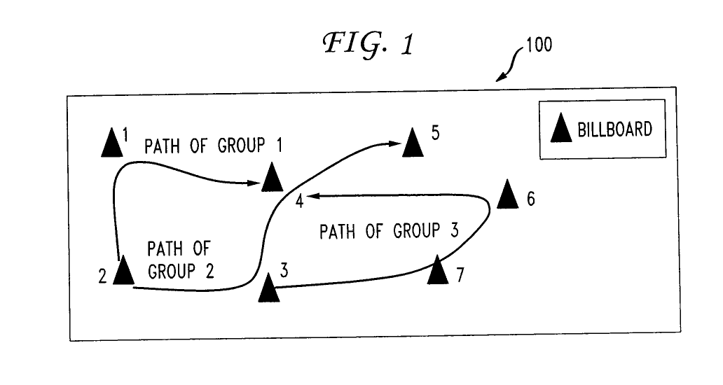

FIG. 1 shows a network 100 of billboards 1, 2, . . . , 7, located in a geographical region, and various paths that exist in the region for the various observed groups. As used herein, the term “network of billboards” signifies a plurality of billboards some or all of which are used to display advertisements to a selected group.

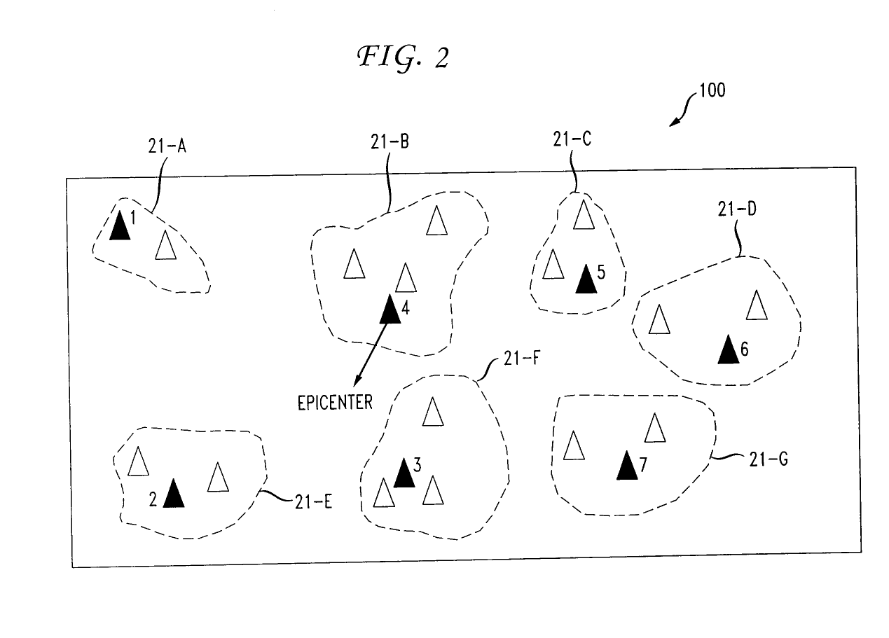

In one embodiment, since a geographical region may contain a plurality of billboards, a proximal set of billboards is represented by a single virtual billboard, or perhaps a representative billboard. For example, all the billboards within one section of a large mall may be represented with one representative billboard. Such a representative billboard is referred to herein as a billboard epicenter. FIG. 2 shows various pluralities of billboards 21-A, 21-B, etc., and respective billboard epicenters within each respective plurality. Thus, billboard 1 is a billboard epicenter of plurality 21-A, billboard 2 is a billboard epicenter of plurality 21-B, etc. Billboard epicenters 1, 2, . . . , 7 correspond to billboards 1, 2, . . . , 7 of FIG. 1.

In general, any one group, given a sufficient amount of time, may move from one billboard to another. Therefore, billboards are not constrained in terms of accessibility with respect to one another. However, individuals usually pass through one or more intermediate billboards before they appear in front of another billboard.

A set of billboards in a region may be considered to form a fully connected graph. However, in practice the graph is not fully connected. In accordance with an embodiment, a set of billboards is viewed as a fully connected graph, and selected edges of the graph that are greater than a certain distance (e.g., x kms) are pruned. Thus any fully connected graph of billboards (or any set of billboards within a geographical region) may be viewed as a graph that is not fully connected by an arbitrary choice of the distance (e.g., x kms) by which the graph is pruned.

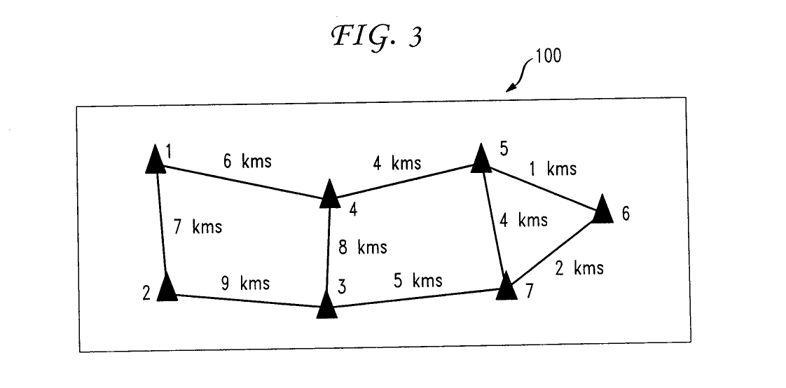

FIG. 3 shows network of billboards 100 within a geographical region and distances between the billboards. FIG. 3 illustrates the fact that in some cases, it is not possible to move from a first billboard in the network to certain other billboards without passing certain intermediary billboards.

In accordance with an embodiment, one or more groups are detected near or in proximity to (for example, in front of, within a predetermined radius of, etc.) one or more of the billboards in network 100, and a path of the group is determined. In various embodiments, one or more of the billboards in network 100 may be located in a mall, a bus station, a metro station in the neighborhood, an office complex, a residence, etc.

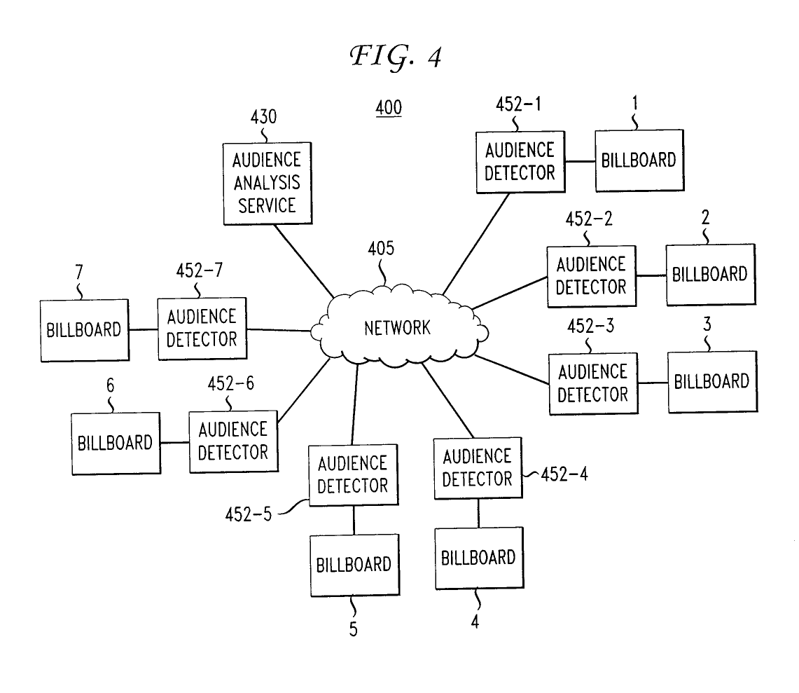

FIG. 4 shows a communication system 400 in accordance with an embodiment. Communication system 400 includes a network 405, an audience analysis service 430, and a plurality of audience detectors 452-1, 452-2, 452-3, . . . 452-7. Each audience detector 452 is associated with, and may be connected to, a respective billboard. Thus, in the illustrative embodiment, audience detector 452-1 is associated with and connected to billboard 1, audience detector 452-2 is associated with and connected to billboard 2, etc.

In the exemplary embodiment of FIG. 4, network 405 is the Internet. In other embodiments, network 405 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 405 may comprise a combination of different types of networks.

For convenience, in the discussion below, the term “audience detector 452” is used to refer to any one of audience detectors 452-1, 452-2, . . . , 452-7. Thus, any discussion herein relating to “audience detector 452” applies equally to any one of audience detectors 452-1, 452-2, . . . , 452-7.

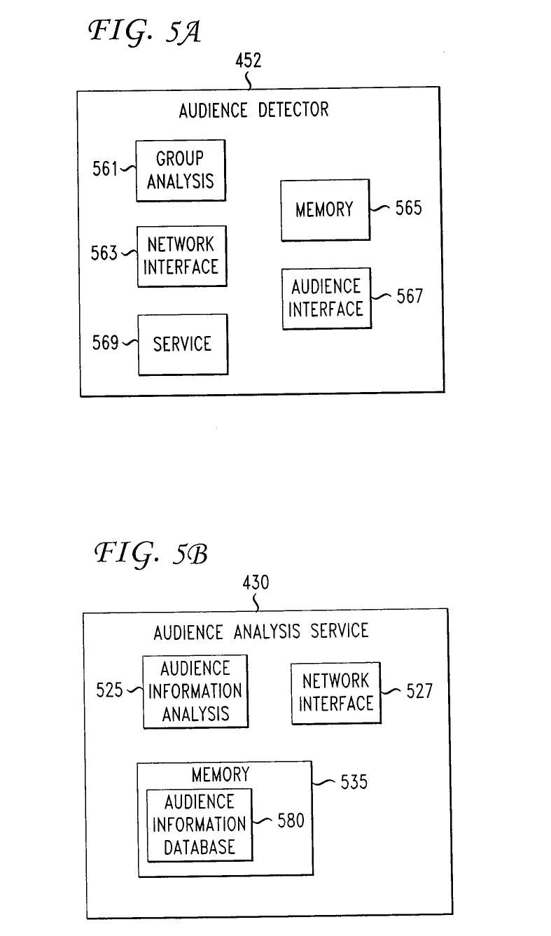

An audience detector 452 associated with a particular billboard comprises a device capable of obtaining audience information concerning individuals who are present or pass near, or are in proximity to (for example, in front of, within a predetermined radius of, etc.) the billboard. For example, audience detector 452-1 may comprise a computer or other processor attached to billboard 1, audience detector 452-2 may comprise a computer or other processor attached to billboard 2, etc. FIG. 5A shows components of an audience detector 452 in accordance with an embodiment. Audience detector 452 comprises a group analysis 561, a network interface 563, a memory 565, a service 569, and an audience interface 567.

Audience interface 567 comprises a device or mechanism capable of obtaining information concerning individuals who are present in front of a billboard. For example, audience interface 567 may include an imaging system capable of capturing images. In another embodiment, audience interface 567 may include a microphone to detect the speech of individuals passing in front of the billboard. In another embodiment, audience interface 567 may comprise an antenna configured to receive data from a cell phone of an individual who passes in front of a billboard. Audience interface 567 transmits audience data to group analysis 561.

Group analysis 561 receives from audience interface 567 audience data concerning individuals who are present in front of the billboard, and analyzes the audience data to identify individuals and/or groups that have been present in front of the billboard. Group analysis 561 transmits the resulting audience information to audience analysis service 430 via network 405.

Service 569 comprises a service that may be offered to individuals who pass in front of the billboard. For example, service 569 may comprise an electronic coupon application that allows an individual to receive an electronic coupon via a cell phone, a game application that allows an individual to play an online game, etc.

Group analysis 561 and service 569 may comprise software and/or hardware, for example.

Network interface 563 comprises a device or mechanism that enables audience detector 452 to communicate via network 405. Memory 565 is used by various components of audience detector 452 to store data.

In one embodiment, an audience detector 452 associated with a particular billboard is capable of interacting with an individual who is present in front of the billboard. For example, an audience detector 452 may cause an individual's cell phone to display an offer for a coupon, or an offer to play a game. When the individual selects an option, audience detector 452 may transmit an electronic coupon to the cell phone or allow the individual to play the desired game. During such interaction, the audience detector may obtain additional information from the cell phone and thereby gather additional information about the individual, such as the individual's name, telephone number, gender, age, address, etc. An audience detector 452 may obtain audience information via a service that it provides, such as free WiFi or Bluetooth, and detect groups using the service during interaction with individuals.

From time to time, each audience detector 452 transmits to audience analysis service 430 audience information comprising data concerning one or more individuals who passed in front of the associated billboard.

In different embodiments, audience detector 452 may have varying degrees of intelligence and analysis capability. For example, audience detector 452 may comprise image analysis functionality, voice recognition functionality, etc. In one embodiment, audience detector 452 may perform an analyses of the audience data captured by audience interface 567 to determine how many people were detected in front of a particular billboard, which groups were present at a particular billboard, etc., and transmit the results of the analysis (indicating which groups were detected and the times at which the groups were detected) to audience analysis service 430. For example, audience detector 452 may generate an analysis of audience data to indicate how many individuals having a first characteristic (e.g., age 25-30) were detected in front of the billboard and the times at which they were detected, how many individuals having a second characteristic (e.g., female) were detected in front of the billboard and the times at which they were detected, etc. In another embodiment, audience detector 452 may have little or no analysis capability, and transmits the audience data captured by audience interface 567 directly to audience analysis service 430, and audience analysis service 130 analyzes the data to determine which groups were present at a particular billboard.

FIG. 5B shows components of audience analysis service 430 in accordance with an embodiment. Audience analysis service 430 includes audience information analysis 525, a network interface 527, and a memory 535.

Audience information analysis 525 receives data, which may include audience information, from audience detectors 452, and stores the information in audience information database 580 (in memory 535). Audience information analysis 525 analyzes the audience information and, if necessary, determines which groups were present at each billboard in network 100, and at which times. For example, audience information analysis 525 may determine that a particular group was present in front of billboard 3 at 11:00 AM and was detected in front of billboard 5 at 3:00 PM on a particular day.

Network interface 527 comprises a device or mechanism that enables audience analysis service 430 to communicate via network 405.

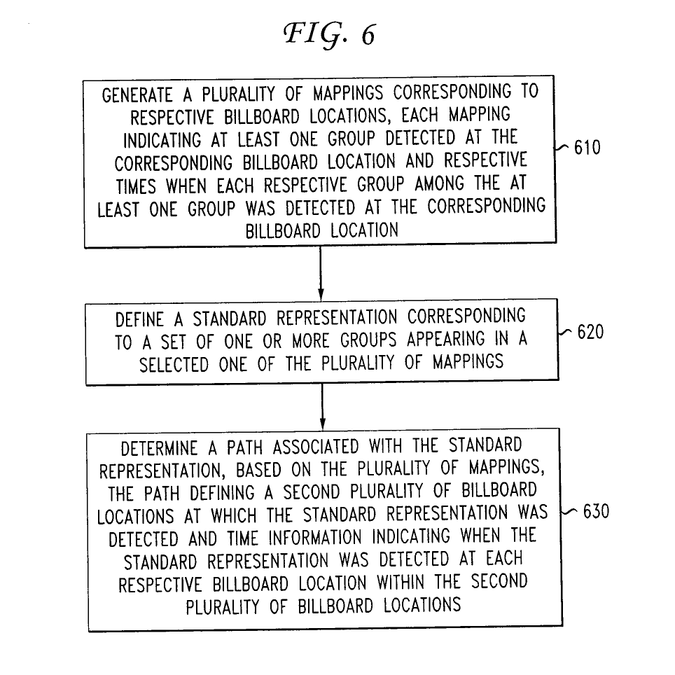

In accordance with an embodiment, audience analysis services 430 receives information from audience detectors 452 and applies the principles and methods described herein to determine paths followed by one or more groups. Audience analysis service 430 may additionally control advertising displayed on billboards 1, 2, 3, . . . , 7 shown in FIG. 1, based on the paths determined. FIG. 6 is a flowchart of a method of determining a path associated with a standard representation in accordance with an embodiment.

At step 610, a plurality of mappings corresponding to respective points of interest is generated. Each mapping indicates at least one group detected at the corresponding point of interest and respective times when each respective group among the group was detected at the corresponding point of interest. As discussed above, audience analysis service 430 receives audience data from audience detectors 452 and stores the audience data in database 580. In one embodiment, audience data is stored and/or analyzed for respective twenty-four hour periods.

Audience information analysis 525 analyzes the data in database 580 to identify groups that were present in front of each billboard. Based on the data, audience information analysis 525 generates a plurality of matrices, or mappings.

At step 620, a standard representation corresponding to a set of one or more groups appearing in a selected one of the plurality of mappings is defined. Audience information analysis 525 examines each mapping and defines a standard representations associated with a selected mapping.

At step 630, a path associated with the standard representation is determined, based on the plurality of mappings. The path defines a second plurality of points of interest at which the standard representation was detected and time information indicating when the standard representation was detected at each respective point of interest within the second plurality of points of interest. Audience information analysis 525 determines a path associated with the standard representation defined at step 620, based on the plurality of mappings.

After a path of the standard representation is determined, advertisements may be selected and displayed on selected billboards based on the path. For example, a particular advertisement may be displayed at a first billboard along the path at a time when the group is expected to be in front of the first billboard, and displayed at a second billboard along the path at a time when the group is expected to be in front of the second billboard. Alternatively, a first advertisement may be displayed at a first billboard along the path at a time when the group is expected to be in front of the first billboard, and a second advertisement may be displayed at a second billboard along the path at a time when the group is expected to be in front of the second billboard. Other marketing strategies may be implemented based on the path.

In one embodiment, an optimal advertisement, and an optimal time to display the advertisement, may be determined for a particular billboard, based on the path information. In another embodiment, in connection with a particular advertising campaign, one or more optimal advertisements, and optimal times to display each advertisement, may be determined for a plurality of billboards in a network of billboards, based on the path information. In another embodiment, a set of coordinated advertisements directed at a particular target group may be displayed on selected billboards in a network of billboards, and at selected times, based on the path information.

Methods and systems for performing steps 610, 620, and 630 are further described below.

As used herein, the term group means a probabilistic group of individuals who share a particular characteristic. In this embodiment, characteristics and groups are defined a priori. For example, a client may request information concerning the movements of individuals in the following groups: (1) females between the ages of 18 and 30; (2) individuals with incomes above $200,000; and (3) individuals who play online computer games. These characteristics and groups are exemplary only and are not to be construed as limiting in any way. Any characteristic(s) and any group(s) may be defined.

Supposing that it is determined that a first group was present in front of a first billboard at a first time and a second group was present in front of a second billboard at another time. It is useful to determine if the groups present in front of each billboard were the same or different, or only marginally different. One approach to this problem is to perform the standard notion of “set intersection” on the two groups, if both of them are such that they completely coincide in group characteristics, then it can be determined that both those groups are actually one and the same. However, most real world scenarios do not coincide completely. And use of a probabilistic notion of a group, as discussed herein, precludes a determination of a complete intersection.

Instead, it is useful to form a notion of the “essence” of one of the groups and then determine if this “essence” is present in the other group. If so, it may be determined that the same essence of the each group is present in front of each billboard. Also, such a determination leads to the conclusion that all monitoring and tracking is required only on this group's essence and not the whole group.

The technique used to determine the “essence” of a group, referred to herein as the “standard representation” of the group, is a new and novel construct. The standard representation is essentially a probabilistic growth around the intersection of the two groups satisfying a certain set of properties. If the intersection is small, it can be grown desirably by taking in members of each group. The members taken from each group obviously follows certain mathematical requirements. It is further noted that there is no constraint in taking equal members from each group. Once this is performed, then the resultant set or group obtained is the standard representation; thus the standard representation is a highly probable set of members that forms the essence of the groups in question.

For example, if there are groups A, B & C, and if the standard representation is R, then R is a group such that it captures the essence of A, B and C with a well defined probability.

Such a definition and construct is useful because groups such as A, B and C are all dynamic in the sense that their constituent members may easily exhibit characteristics of another group at a later time or another place. In other words members of groups such as A, especially those that barely make it to the classification of A, may very easily exhibit properties of group B at another time or place. Thus, the standard representation is a construct used to answer the question: if it is necessary to replace two groups with just one, then what is the nature of the replacement, and what does it look like.

A detailed mathematical explanation of the standard representation is provided in the section of this specification entitled “Mathematical Explanation.”

Another construct used herein is referred to as the standard occurrence, and is obtained by loosening some of the constraints of the definition of the standard representation. A standard occurrence is a construct required to answer the question: is it possible to observe a defined set of characteristics with high probability in a given group. Or in other words, has the essence of a group been observed in another group with some probability.

A detailed mathematical explanation of the standard occurrence is provided in the section of this specification entitled “Mathematical Explanation.”

### Conceptual Discussion of the Method

The following discussion describes, at a conceptual level, the steps of identifying groups, identifying standard representations of groups, and determining the paths followed by the groups, in accordance with an embodiment.

At every billboard a determination is made whether certain characteristics are prominent, and if so do they appear during multiple time intervals or do they appear during just one instance of measurement.

The use of the standard representation is useful here, because the group itself may be replaced by the standard representation of the group. The standard representation may then be considered to be prominent during multiple time intervals.

Suppose that it is desirable to examine some predefined number of groups or characteristics, say K of them. It is to be also noted that since these are real time measurements of events, the events are classified in time intervals of 1 hour, and therefore there will be 24 such time intervals for a day's worth of measurements.

Once the K most prominent groups at a billboard have been determined, then the notion of the standard occurrence is used to determine if these groups have been observed elsewhere (i.e., in front of other billboards). If so, the billboard sites are arranged in order of time at which a certain group is observed. Therefore for each group of interest, an ordered collection or set of billboards is obtained. In all, since there are K such groups, K such ordered sets of billboards are obtained.

Within each ordered set of billboards, since they are ordered on time, there may be some billboards that have the same time value. The ones that have the same time value are re-sorted by their distance to each other. Now a path or flow of a group across the collection of billboards in a geographical area is obtained. Note that there will be K such paths.

Step 1: Determine the distributions at a billboard epicenter for various time intervals ‘t’. A good value of t is 1 hour or more. The distributions are determined by counting the number of individual interactions with the billboard. The count may also include the number of people present within a certain radius of the billboard at the time of the interaction.

Suppose that A(t1) and A(t2) represent the distributions at intervals t1, t2, and so on.

Now, A(t1), A(t2), . . . A(tN) is decomposed as a union of utmost K unimodal distributions. This is possible without loss of too much data for sufficiently large K. The value K represents the traits or the kinds of “target groups” that are being examined.

A(t1)=_{i=1 . . . K}U(Aᵢ^{t1})

A(t2)=_{i=1 . . . K}U(Aᵢ^{t2}) . . . A(tN)=_{i=1 . . . K}U(Aᵢ^{tN})

Step 2: (Recombination Step): Now a method called “Recombination,” defined as follows, is performed:

Start with A which is the union of the various modes of A(t1) and A(t2), i.e. A has components (Aᵢ^{t1}, A₂^{t1}, . . . A_{K}^{t1}, A₁^{t2}, A₂^{t2}, . . . A_{K}^{t2}). Now, order A's components along the abscissa. I.e.

A=(A₁^{t1},A₁^{t2},A₂^{t1},A₂^{t2}, . . . A_{K}^{t1},A_{K}^{t2})

Replace every adjacent pair Aᵢ^{t1} and Aᵢ^{t2} with its “standard representation” if one exists, i.e. by Ψ(p, Aᵢ^{t1}·Aᵢ^{t2}). Else, leave them as it is. Ψ(p) is defined below.

At the end of this process a distribution A is obtained, that has utmost 2K modes. Now, K-prune this distribution A, leaving a distribution A′ that is a “Recombination of the two distributions”. This step may be performed by applying Theorem 3 (described in the section of this specification entitled “Mathematical Explanation”).

Step 3: (Marking Step): Viewing A′ as a union of utmost K components (since it is K-modal), mark down the time intervals of the various components. An array indexed by the time interval, and whose values are the components, is built. For example, in order to follow four characteristics (K=4), let A(t1) and A(t2) be given as

A(t1)=A₁^{t1},A₂^{t1},A₃^{t1},A₄^{t1}

And A(t2)=A₁^{t2},A₂^{t2},A₃^{t2},A₄^{t2}

On completion of step 3 the following is obtained:

A′=A₁^{t1},A′₂^{t1,t2},A₃^{t2},A₄^{t1}

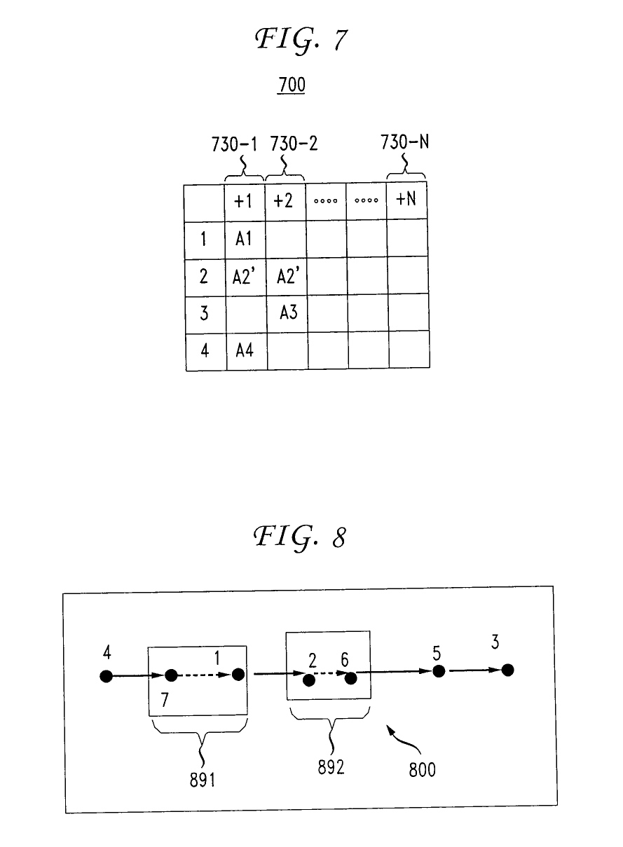

An array is obtained, also expressed herein as a mapping or matrix, such as that shown in FIG. 7. Mapping 700 comprises columns 730-1, 730-2, . . . , 730-N, corresponding to time intervals t1, t2, . . . , tN, respectively.

Note in this example, since component A2′ (which is a “standard representation” of both A₂^{t1} and A₂^{t2}) occurs, it is marked against both time intervals.

Step 4 (Propagation Step): Repeat step 3 between A(t2) and A(t3), and similarly mark down the components against the time intervals into the two dimensional array (step 3). If a particular cell was marked earlier by a “standard representation,” the new value to be marked is either the same value or a new “standard representation”, or a blank. If the new value is a blank or equal to the same value, do not mark. Else, if the new value is another “standard representation”, then mark the cell and also every element of that row, from interval t1, all the way to that particular interval.

For example, after recombination of A(t2) and A(t3), lets say A2′ under column t2 is to be marked by a blank, then it is omitted. If however, A2′ is to be marked by a new “standard representation” A2″, then replace A2′ with A2″ under column t1 also.

Next repeat this procedure between A(3) and A(4), and so on until A(tn−1) and A(tn). Finally repeat the procedure between A(tn) and A(t1). Programmatically:

A(tn+1) = A(t1);
for (i=2...N+1) {

A′ = Recombination of A(ti) & A(ti+1)

Mark down the time intervals in A′ in columns ti & ti+1.
}

It is to be noted that essentially a characteristic is marked, only if it occurs in at least two successive time intervals.

At the end of step 4, a matrix of components (against each time interval) is obtained for each billboard epicenter. In other words, each billboard epicenter has one component matrix.

Step 5: an arbitrary or a predetermined billboard epicenter is selected, called the focal point ‘f’. K arbitrary unique cells are chosen from its corresponding matrix. For example, a good choice is to choose them such that they are the K largest sizes. If there are M<K unique components, then K−M are chosen from f's next closest neighbor, and so on. These K cells are called the K focal components, or simply focal components. Essentially, the path of these focal components is followed or traced, as these are the characteristics for which a path is to be obtained.

K predetermined components may also be chosen. Nevertheless, at the end of step 5, K components are obtained, referred to as target groups or characteristics to be followed.

Step 6: Supposing that there are V billboard epicenters in the given graph, then for each of the K focal components, determine if there is a standard occurrence with any cell of component matrix. If so, mark the time interval (or column number), and also the epicenter id. Programmatically,

For (i= 1 through K of focal components) {

For (j = 1 through V of component matrices) {

```
  If there exist a “Standard Occurrence” of component i with
  any cell
```

of matrix J; then

Insert the tuple (column number of that cell in matrix j, epicenter j)

into array P[i].

}

}

At the end of step 6, arrays P[1] thru P[K] is obtained. For example:

P[3]=(t1,4),(t11,3),(t5,6),(t4,1),(t4,7),(t5,5),(t5,2)

It is noted that each of these arrays is a representation of the path followed by each of the characteristics (focal components) that are being followed.

Step 7: Sort every P[i] on the first element of the tuple, i.e time interval. Using the above example, the following path is obtained:

P[3]=(t1,4),(t4,1),(t4,7),(t5,6),(t5,5),(t5,2),(t11,3)

Step 8: If after step 7, there are N items of P[i], that have the same time value, and occupy the indices j+1 thru j+N, then re-arrange, or order, them such that, the first of those N items is closest to item indexed j+1, and last of those N items is closest to item indexed j+N+1. (The definition of ‘close’ refers to the distance between billboards).

Now the item indexed by j+1 closest to item indexed by j is obtained, and item indexed by j+N closest to item indexed by j+N+1 is obtained.

This is repeated similarly for indices j+2 and J+N−1, and so on until all N items are ordered this way.

At the end of step 8, using the example above, the following path is obtained:

P[3]=(t1,4),(t4,7),(t4,1),(t5,2),(t5,6),(t5,5),(t11,3)

It is noted that billboard 7 is closest to billboard 4 and billboard 1 is closest to billboard 2.

This represents the path taken by the third focal component in time.

FIG. 8 illustrates a path P[3] (800) defined in the example above in accordance with an embodiment. The group is detected at billboard 7 and at billboard 1 in the same time interval (as shown by box 891) and is detected at billboard 2 and at billboard 6 in the same time interval (as shown by box 892).

In the above example, the path or flow of a group across the collection of billboards in a geographical area is shown. K such paths are obtained, each computed in the manner described above.

Therefore in the illustrative example, a particular group travels from billboard 4 to billboard 3, in accordance with the path shown above. This particular group has a certain characteristic; accordingly, advertisements may be displayed at selected times along the path, as the day progresses. Also a billboard may be displayed at billboard 4, and repeated at billboard 7 and billboard 1, and certain other related advertisements may be displayed at billboard 2, 6, 5, and 3. Therefore, one or more advertisements may be displayed at one or more selected billboards in the network of billboards based on the path determined in the manner described above.

Moreover, keywords may be designated along the path that results in the best conversion rate for the advertisements displayed. For example, at billboard 4 keywords such as “shoes” and “drinks” may show a good conversion rate, whereas at billboard 5, the best keywords may be “socks,” “tennis,” and “soccer.”

### Mathematical Explanation

The following discussion sets forth a mathematical explanation for certain concepts including the standard representation and standard occurrence.

A “P Probabilistic Intersection” of two sets A & B is denoted by Ψ(p, A·B), where A·B stand for the intersection of A & B. When sets A & B are implicit, then the notation Ψ(p) is used.

Ψ(p) is defined, such that Ψ(p) consists of elements in A or B, and satisfies

1. A·B⊂Ψ(p)⊂(AUB) (1)

2. Ψ(p) is convex (2)
3. Let Δ denote the Area or Volume function, then

Δ(Ψ(p))=(2−p)Δ(A·B) (3)
4. The mahalanobis distance between the centroids of A·B and Ψ(p) is bounded by the uncertainty, that is:

Dₘ=(C_{A·B}−C_{Ψ})^{T}S⁻¹(C_{A·B}−C_{Ψ})≦(1−p) (4)

Where, C_{A·B} is the vector representing the centroid of A·B, C_{Ψ} is the vector representing the centroid of Ψ(p), and S⁻¹ is the covariance matrix.

When p=1, then Ψ(p)=A·B.

Thus, a 100% probability or “1 Probability Intersection” of two histograms is the traditional notion of intersection.

Also it is noted that, in general
a) A & B can be two distributions, or ‘probability spaces’,
b) The notion of A and B can be extended to a finite set of distributions denoted by X₁, X₂, . . . X_{N}. Then Ψ(p, ^{i=N} Πᵢ₌₁(Xᵢ)) is the “P Probabilistic Intersection” of these N distributions.
c) A & B can occupy a multidimensional space

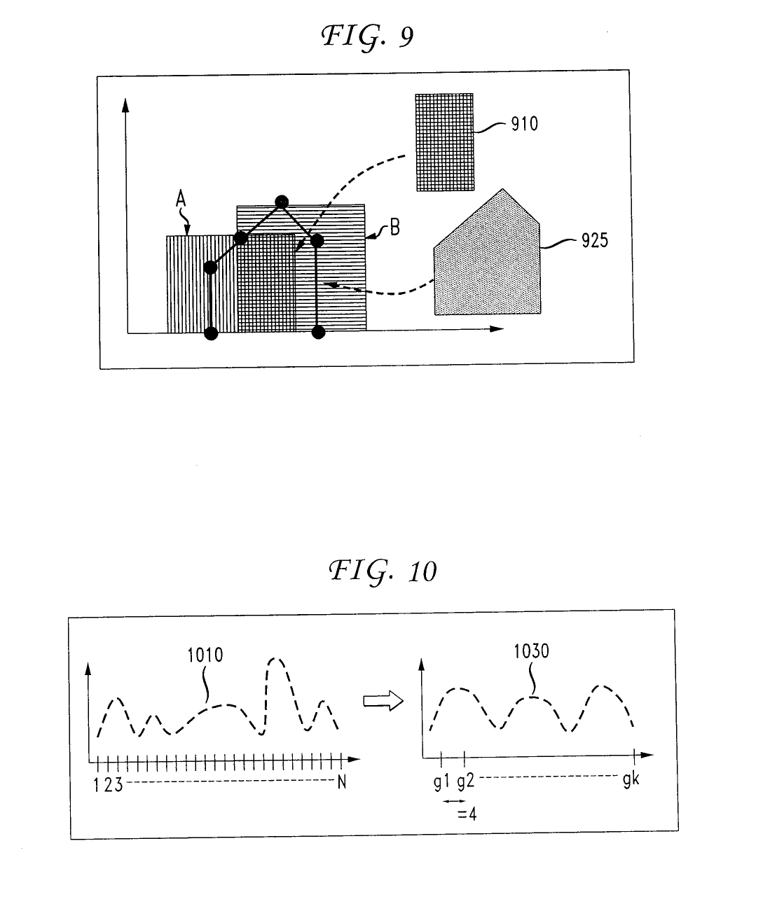

FIG. 9 shows an analysis of two histograms in accordance with an embodiment. In particular, FIG. 9 shows a first histogram A and a second histogram B, a shape of a complete intersection 910 of the two histograms, and a shape of a “P Probabilistic Intersection” 925 of the two histograms.

### Variations:

1) If condition 4 in the above definition is relaxed to only mean the Euclidean distance (instead of the mahalanobis distance), the following intersection is referred to as a “P probabilistic relaxed centered Intersection”. Thus, condition 4 is replaced with

D_{E}[(C_{A·B}−C_{Ψ})·(C_{A·B}−C_{Ψ})]^{1/2}≦(1−p) (4a)

2) When condition 4 is completely removed, Ψ(p) is referred to as the “P probabilistic uncentered Intersection”.

3) In any “P probabilistic uncentered Intersection”, if

AΠ(Ψ(p)−A·B)=Max^{i=1 . . . n}[AᵢΠ(Ψ(p)−A·B)] (4b)

Ψ(p) is then referred to as a “P probabilistic A-biased Intersection”, the “degree of the bias” is expressed as the ratio

θ=Δ(AΠΨ(p))/Δ(Ψ(p)) (4c)

It is advantageous to express equations (4b) and 4(c) as partial derivatives and/or Gaussian integrals, because that way, the maximality and degree of bias are captured more effectively.

It is noted that every “P probabilistic uncentered Intersection” is a “P probabilistic X-biased Intersection” with some given degree of bias θ for Distribution X.

4) In any “P probabilistic uncentered Intersection”, let

Δm=Max(Δ(A),Δ(B), . . . ) (4d)

Then, for some arbitrary Φ, such that (0<Φ≦1), it is said that Ψ(p) is a “P Probabilistic representative Intersection” if

Δ(Ψ(p))/Δm≧Φ

The ratio Φ is known as the “degree of representation” Given a particular value of Φ, it is not guaranteed to find a “P Probabilistic representative Intersection”. On the contrary, for every Ψ(p) there is a value Φ, however small, for which Ψ(p) is a “P Probabilistic representative Intersection” of degree Φ.

### Special Case 1

If there exists a “P probabilistic uncentered Intersection” Ψ(p), such that p=0.75, and Φ=0.5, Ψ(p) is referred to as the “standard representation” of the two distributions.

### Special Case 2

If there exists a “P probabilistic Intersection” Ψ(p), such that p=0.75, and Φ=0.33, Ψ(p) is referred to as the “standard Occurrence”.

### Intuitive Explanation:

A “P probabilistic Intersection” is the area of finding the maximum likelihood of A·B within a probability factor P. In many real world scenarios, groups are dynamic, and elements at the fringe of one group may acquire properties of another group. Examples of such dynamism are:
1) Some people in one age group (especially those near the boundary) are likely to behave or acquire characteristics of another age group.
2) It is known that viruses are protein structures that may change under certain conditions. Given this dynamism in structure, a given protein structure that displays a certain set of properties may well start behaving or exhibiting another set of properties with some probability.
3) Members of one social or socio-economic group, especially those at the periphery, may start exhibiting characteristics of another socio-economic group.
4) When cells start reproducing uncontrollably it leads to cancer. When cancer becomes malignant even normal healthy cells within an area, or of a specific organ, and displaying some known characteristics may turn cancerous.
5) In pattern recognition, image recognition, and computer vision, there are probability distributions for characters, images, and items as a whole. Some items within one distribution also have a non-zero probability of occurring within another distribution. Most recognition algorithms use the “Gaussian Weighted Histogram Intersection” (GWHI) or the “Histogram Intersection” (HI) based algorithms. A “P Probabilistic Intersection” more effectively captures the list of all possible recognitions.

Since real world scenarios are dynamic, effective monitoring, tracking, or targeting of a specific set of properties requires the notion of “P probabilistic Intersection” of those properties to effectively handle both accuracy and totality.

Thus, a “P Probabilistic Intersection” is a measure of diffusion of a set of properties beyond its boundary. Alternatively, Ψ(p) may be viewed as a measure of the propensity of a group in exhibiting multiple predefined properties.

A more detailed discussion of condition 4, whose variations determine the various flavors of Intersections, is set forth below.

It is noted that condition 4 refers to the fact that the “P Probability Intersection” should be centered around the traditional notion of Intersection. However, the centers need not necessarily coincide, but is given a play in the sense that it has to be bounded by the probability factor to which the “P Probabilistic Intersection” is required. Thus, the distance between the two centers in question should be indicative of the probability P. In the Cartesian coordinate system the notion of distance is usually Euclidean, however Euclidean distance does not take into consideration the probability densities of the two distributions. In order for this distance to be normalized by the standard deviations or the variance of the two distributions in question, the notion of the “mahalanobis distance” is used.

### Centeredness

When a criterion is not placed on the “centeredness” of a “P Probabilistic Intersection” then there is an allowance for the fact that Ψ(p) can be such that there are more elements from one given distribution than another. Thus, “uncentered” Ψ(p) is biased more towards one distribution than another. This bias is indicative of real life scenarios, as certain properties may be given more importance than certain other properties.

### Special Cases

When dealing with probability distributions, many times it is required to find a region that captures the characteristics of all the individual distributions to a certain level of confidence. If such a region can be found then it can be claimed that this special region manifests itself across those individual distributions. In other words, this special region is the quintessence of all those distributions and for all practical purposes this region, thus named “standard representation”, can replace these multiple distributions. Monitoring, tracking and following the characteristics of this standard representation become easier than tracking individual distributions and also more effective.

While tracking, a stricter rule is used in the centeredness of Ψ(p), but its Φ value is relaxed. This comes from the notion of normal subgroups. An event occurred if at least one of its normal subgroups is present.

### Theorem 1 (Interval-Merging):

Given a multi-modal distribution in Cartesian coordinates, where the elements in the abscissa form a “totally ordered group”, G, over some relation ‘R’, then it is possible to reduce the number of modes in the distribution, over a new abscissa G′ (also a totally ordered group), such that there exists a Subjective Homomorphism between G and G′.

Proof: It is required to prove that any M-modal distribution over a totally ordered group, can be reduced to a N-modal distribution, for some 1≦N<M.

A brief constructive proof is provided to show that this is true. This process is also referred to as modal merging or Interval merging.
1) Choose a number J>1 (start with 1.5 or 2, typically)
2) Redraw the distribution such that the new abscissa interval is J*original interval size.
3) If the new Distribution is not Modally reduced, then repeat step 2, with a higher value of J (typically increments of 0.5)

The rest of the proof follows readily, as will be evident to those skilled in the art.

FIG. 10 illustrates reduction of an M-modal distribution 1010 over a totally ordered group to a N-modal distribution 1030 in accordance with an embodiment.

### Definition: Distribution Pruning:

Given a M-modal distribution A, and an integer K, such that (1≦K<M), a “K-Pruned Distribution” of A, is given by A′ such that A′⊂A, and A′ is K-modal.

The definition requires both distributions to be over the same abscissa, and therefore Interval-merging cannot be used.

Theorem 2: Every M-modal distribution, can be K-pruned, for some (1≦K<M).

Proof: Let a distribution A be M-modal. This means A can be represented as the union of M unimodal distributions (components). Certain components can be arbitrarily dropped, leaving a subset of A that is now a union of less than M components, or in other words K-modal.

From the definition of a “P Probability Representative Intersection”, it is clear that there exists at least one arbitrary distribution A′, such that A′ is K-pruned, and is a “P Probability Representative Intersection” of degree Φ, such that (Φ>0).

Theorem 3: It is possible to find a K-pruned distribution of a 2K-modal distribution such that, the K-pruned distribution is a “standard representation” (Φ≧0.5).

Considering X as the union of 2K unimodal distributions (components), the components can be arranged in order of increasing area (or size). Starting from largest size, each component is added to a distribution Y. This step is repeated until the largest K components are added. The result is a distribution Y that satisfies Y⊂X, is K-modal, and whose (Φ≧0.5). Since Y is a subset it is a “P Probability representative Intersection”, and therefore a “standard representation”.

In various embodiments, the method steps described herein, including the method steps described in FIG. 6, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 6. Certain steps of the methods described herein, including one or more of the steps of FIG. 6, may be performed by a server or by another processor in a network-based cloud-computing system. Certain steps of the methods described herein, including one or more of the steps of FIG. 6, may be performed by a client computer in a network-based cloud computing system. The steps of the methods described herein, including one or more of the steps of FIG. 6, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 6, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

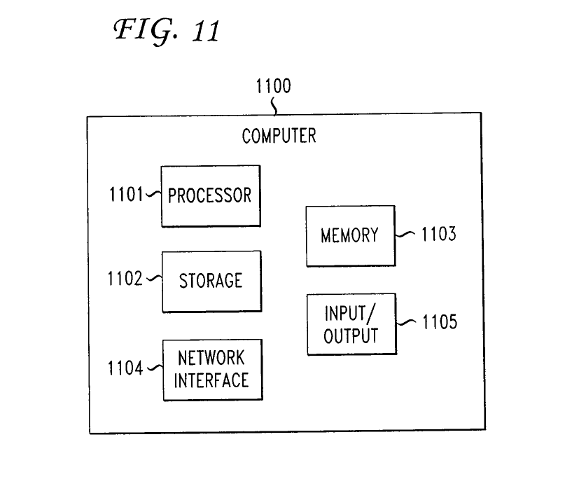

A high-level block diagram of an exemplary computer that may be used to implement systems, apparatus and methods described herein is illustrated in FIG. 11. Computer 1100 includes a processor 1101 operatively coupled to a data storage device 1102 and a memory 1103. Processor 1101 controls the overall operation of computer 1100 by executing computer program instructions that define such operations. The computer program instructions may be stored in data storage device 1102, or other computer readable medium, and loaded into memory 1103 when execution of the computer program instructions is desired. Thus, the method steps of FIG. 6 can be defined by the computer program instructions stored in memory 1103 and/or data storage device 1102 and controlled by the processor 1101 executing the computer program instructions. For example, the computer program instructions can be implemented as computer executable code programmed by one skilled in the art to perform an algorithm defined by the method steps of FIG. 6. Accordingly, by executing the computer program instructions, the processor 1101 executes an algorithm defined by the method steps of FIG. 6. Computer 1100 also includes one or more network interfaces 1104 for communicating with other devices via a network. Computer 1100 also includes one or more input/output devices 1105 that enable user interaction with computer 1100 (e.g., display, keyboard, mouse, speakers, buttons, etc.).

Processor 1101 may include both general and special purpose microprocessors, and may be the sole processor or one of multiple processors of computer 1100. Processor 1101 may include one or more central processing units (CPUs), for example. Processor 1101, data storage device 1102, and/or memory 1103 may include, be supplemented by, or incorporated in, one or more application-specific integrated circuits (ASICs) and/or one or more field programmable gate lists (FPGAs).

Data storage device 1102 and memory 1103 each include a tangible non-transitory computer readable storage medium. Data storage device 1102, and memory 1103, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1105 may include peripherals, such as a printer, scanner, display screen, etc. For example, input/output devices 1105 may include a display device such as a cathode ray tube (CRT) or liquid crystal display (LCD) monitor for displaying information to the user, a keyboard, and a pointing device such as a mouse or a trackball by which the user can provide input to computer 1100.

Any or all of the systems and apparatus discussed herein, including audience analysis service 430, audience detectors 452 and components thereof, including group analysis 561, memory 565, audience interface 567, service 569, network interface 563, audience information analysis 525, network interface 527, and memory 535, may be implemented using a computer such as computer 1100.

One skilled in the art will recognize that an implementation of an actual computer or computer system may have other structures and may contain other components as well, and that FIG. 11 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
generating a plurality of mappings corresponding to respective points of interest, each mapping indicating at least one group detected at the corresponding point of interest and respective times when each respective group was detected at the corresponding point of interest;
defining a standard representation corresponding to a set of one or more groups appearing in a selected one of the plurality of mappings;
determining a path associated with the standard representation based on the plurality of mappings, the path defining a second plurality of points of interest at which the standard representation was detected and time information indicating when the standard representation was detected at each respective point of interest within the second plurality of points of interest.

2. The method of claim 1, wherein at least one point of interest comprises a location associated with a billboard.

3. The method of claim 1, further comprising:
detecting the set of one or more groups in an area associated with a particular point of interest corresponding to the selected one of the plurality of mappings.

4. The method of claim 3, wherein the step of defining a standard representation corresponding to the set of one or more groups appearing in the selected one of the plurality of mappings further comprises:
determining an intersection of the set of one or more groups;
determining a probabilistic growth around the intersection; and
defining the standard representation based on the intersection and the probabilistic growth.

5. The method of claim 4, wherein the step of determining a path associated with the standard representation further comprises:
generating an array associated with the standard representation, based on the plurality of mappings, the array comprising one or more sets of coordinates associating respective points of interest with respective times, the array being generated by:
identifying, within the plurality of mappings, a plurality of standard occurrences of the standard representation;
for each of the plurality of standard occurrences identified, generating a set of coordinates indicating a time and a point of interest associated with the respective standard occurrence.

6. The method of claim 5, wherein a standard occurrence of the standard representation comprises a representation of the set of one or more groups detected at a plurality of points of interest.

7. The method of claim 5, wherein the step of identifying a standard occurrence of the standard representation further comprises:
identifying a P probabilistic relaxed centered intersection.

8. The method of claim 7, further comprising:
ordering the second plurality of points of interest based on distances between the points of interest.

9. The method of claim 1, further comprising:
displaying one or more advertisements at one or more selected points of interest, based on the determined path.

10. A non-transitory computer readable recording medium comprising computer program instructions stored therein which, when executed by a processor, define the steps of:
generating a plurality of mappings corresponding to respective points of interest, each mapping indicating at least one group detected at the corresponding point of interest and respective times when each respective group among the at least one group was detected at the corresponding point of interest;
defining a standard representation corresponding to a set of one or more groups appearing in a selected one of the plurality of mappings;
determining a path associated with the standard representation, based on the plurality of mappings, the path defining a second plurality of points of interest at which the standard representation was detected and time information indicating when the standard representation was detected at each respective point of interest within the second plurality of points of interest.

11. The non-transitory computer readable recording medium of claim 10, further comprising program instructions defining the step of:
detecting the set of one or more groups in an area associated with a particular point of interest corresponding to the selected one of the plurality of mappings.

12. The non-transitory computer readable recording medium of claim 11, wherein the program instructions defining the step of defining a standard representation corresponding to the set of one or more groups appearing in the selected one of the plurality of mappings further comprise program instructions defining the steps of:
determining an intersection of the set of one or more groups;
determining a probabilistic growth around the intersection; and
defining the standard representation based on the intersection and the probabilistic growth.

13. The non-transitory computer readable recording medium of claim 12, wherein the program instructions defining the step of determining a path associated with the standard representation further comprise program instructions defining the step of:
generating an array associated with the standard representation, based on the plurality of mappings, the array comprising one or more sets of coordinates associating respective points of interest with respective times, the array being generated by performing the following steps:
identifying, within the plurality of mappings, a plurality of standard occurrences of the standard representation;
for each of the plurality of standard occurrences identified, generating a set of coordinates indicating a time and a point of interest associated with the respective standard occurrence.

14. The non-transitory computer readable recording medium of claim 13, wherein the program instructions defining the step of identifying a standard occurrence of the standard representation further comprise program instructions defining the step of:
identifying a P probabilistic relaxed centered intersection.

15. The non-transitory computer readable recording medium of claim 14, further comprising program instructions defining the step of:
ordering the second plurality of points of interest based on distances between the points of interest.

16. The non-transitory computer readable recording medium of claim 10, further comprising program instructions defining the step of:
displaying one or more advertisements at one or more selected points of interest, based on the determined path.

17. A system comprising:
a plurality of group detectors associated with respective points of interest, each group detector configured to:
detect a presence of a group in proximity to the associated point of interest; and
transmit information relating to the presence of one or more groups; and
a processor configured to:
receive the information from the plurality of group detectors;
generate a plurality of mappings corresponding to respective points of interest, each mapping indicating at least one group detected at the corresponding point of interest and respective times when each respective group among the at least one group was detected at the corresponding point of interest, based on the information;
define a standard representation corresponding to a set of one or more groups appearing in a selected one of the plurality of mappings; and
determine a path associated with the standard representation, based on the plurality of mappings, the path defining a second plurality of points of interest at which the standard representation was detected and time information indicating when the standard representation was detected at each respective point of interest within the second plurality of points of interest.

18. The system of claim 17, wherein at least one point of interest comprises a location associated with a billboard.

19. The system of claim 17, wherein a group detector associated with a particular point of interest comprises one of a camera and a microphone.

20. The system of claim 17, wherein a group detector associated with a particular point of interest is further configured to:
communicate with a cell phone of an individual who is in proximity to the particular point of interest.
